(19) United States
(12) Patent Application Publication
(10) Pub. No.: US 2025/0367581 A1
(43) Pub. Date: Dec. 4, 2025

(54) FILTRATION SYSTEM WITH NO FILTER NO RUN MECHANISM

(71) Applicant: MANN+HUMMEL GmbH, Ludwigsburg (DE)

(72) Inventors: Mohamed Ghouse MOINUDDIN SHA, Tumkur (IN); Paramesh GANGAPPA, Bengaluru (IN); Basil PAUL KALLUMGAL, Bengaluru (IN); Charan SRIDHARA MURTHY, Bengaluru (IN); Anshul VERMA, Bengaluru (IN)

(21) Appl. No.: 19/298,465

(22) Filed: Aug. 13, 2025

Related U.S. Application Data
(63) Continuation of application No. PCT/EP2024/052856, filed on Feb. 6, 2024.

(30) Foreign Application Priority Data
Feb. 15, 2023 (IN) 202341010076

(51) Int. Cl. B01D 35/14

(52) U.S. Cl. CPC B01D 35/14; B01D 2201/0415; B01D 2201/291

(57) ABSTRACT

A filtration system with a “no filter no run” mechanism includes a filter head assembly, a filter housing assembly, and a filter element assembly. The filter element assembly including an axial pin member movably disposed within the filter housing assembly to interact with the filter head assembly. The filter head assembly includes a filter head enclosure including an inlet opening having a tapered profile, a blocking element blocking the inlet opening, and a locking cap. When the filter element assembly is moved from a first position to a second position, the axial pin member pushes the blocking element to clear the inlet opening and upon removal of the filter element assembly, the blocking element drops along the tapered profile of the inlet opening.

### CROSS-REFERENCE TO RELATED APPLICATIONS

This application is a continuation application of international application No. PCT/EP2024/052856 having an international filing date of Feb. 6, 2024, and designating the United States, the international application claiming a priority date of Feb. 15, 2023, based on Indian patent application Ser. No. 202341010076, the entire contents of the aforesaid international application and the aforesaid Indian patent application being incorporated herein by reference.

### TECHNICAL FIELD

The present invention relates to a filtration system, more specifically to a fuel filtration system having a “no filter no run” feature that prevents flow of fluid (e.g., fuel) to an engine or fuel injection system if either no filter is installed, or a non-compatible or non-functioning filter is installed in a filter housing. This mechanism is particularly useful for an internal combustion engine.

### BACKGROUND

The fuel-based engines, specifically internal combustion engines are generally known to combust a mixture of fluid fuel such as diesel and air in a combustion chamber. The mixture then enters the engine. However, the mixture of fuel and oil, is typically passed through filter elements to remove contaminants such as external unwanted particulates, dust, water, etc. from the fluids prior to delivery to the engine.

The filter elements require periodic replacement as the filtering foundations inside of the filter elements get saturated as it captures and removes the contaminants from the fluids passing through the filter media. When the filter element is replaced, unauthorized or non-genuine replacement filter elements may be installed in the filtration systems during servicing operations. The unauthorized and non-genuine replacement filter elements may be of inferior quality to genuine, authorized filter elements. The use of unauthorized or non-genuine replacement filter elements may cause damage to the engine by allowing contaminants past the filter element.

Accordingly, in many applications, it is desirable to implement various engine integrity protection features in the filtration system to have a fuel filtration system in which the flow of fuel to an engine is prevented if no filter cartridge is installed, or if an incorrect filter cartridge is installed. The operation of an engine with no filter cartridge installed or with an incorrect filter cartridge installed may result in a degradation of engine performance or permanent damage to the engine. Such filtration systems are known as systems having a “no filter no run”' mechanism.

One such known “no filter no run” mechanism includes a valve in a fluid filter housing to control fluid flow through the housing. US 20150273369 discloses one such mechanism having a valve, which describes a “no filter no run” filter system. In an exemplary embodiment, US '369 describes that the flow restriction valve includes a valve body, a valve support, and a valve ball that is configured to restrict fluid flow through the valve when no filter cartridge or an incorrect filter cartridge is installed in the filter housing. A pin engages the opening of the valve such that the ball is prevented from blocking the flow of fluid when a designated filter cartridge is installed in the filter housing.

However, the prior teaching is mostly about chambered flow channel and side-to-side movement of ball due to pin. There exists no such mechanism in prior arts which ensures that the blocking element such as the ball, returns to the center of the fuel inlet opening and positively closes the opening once the filter element assembly is removed or when the filter element is absent. Further, due to absence of any guiding or biasing features, the blocking element in the existing system is prone to be lifted in the direction of flow of the fluid and/or get stuck in some intermediate position that may interfere with the continuous supply of fuel to the engine.

Therefore, there is always a need for improvement in a filtration system having a “no filter no run” mechanism. And with a view to overcome the above discussed drawbacks associated with a conventional filtration system having a “no filter no run” mechanism, the inventors of the present invention devised a novel filtration system constructed in a manner which is not limited to using a valve member or unbiased movement of any blocking element. Further the present filtration system includes a simpler mechanical assembly which is easy to assemble with a compact design and a smaller number of components.

### SUMMARY

It is a general object of the invention to provide a filtration system with a “no filter no run” mechanism for providing filtered fluid to an engine such that fluid flow to the system is prevented when no filter cartridge or an incorrect filter cartridge is installed in the system.

It is one object of the invention to provide a filtration system including a suction tube with an axial pin member and a filter head assembly having a tapered profile inlet opening such that when a designated filter element is inserted the axial pin member pushes a blocking element within the filter head assembly to clear the inlet opening and thereupon allow the flow of fuel towards the outlet opening, and when the filter element assembly is removed, the blocking element drops along the tapered profile of the inlet opening and restricts the flow of fuel through the inlet opening.

It is another object of the invention to provide a filtration system including a suction tube with a protuberance and a filter head assembly having a slider cap being biased to cover the inlet opening for restricting flow of fuel through the inlet opening, a stopper valve coupled with the slider cap and a biasing member coupled between the slider cap and the stopper valve, such that when a designated filter element is inserted, the protuberance pushes the slider cap against the biasing of the biasing member along the stopper valve to clear the inlet opening and thereupon allow the flow of fuel towards the outlet opening.

It is yet another object of the invention to provide a filtration system including a suction tube with a plurality of protruding lips defining female slots and a filter head assembly having a movable lock slider including a cylindrical stopper, plurality of male ribs and plurality of extension legs, such that when a designated filter element is inserted, the extension legs engage with the corresponding slots of a stationary guide member, and the protruding lips push the cylindrical stopper to clear the inlet opening and thereupon allow the flow of fuel towards the outlet opening.

Accordingly, the present invention provides a filtration system with a “no filter no run” mechanism for providing filtered fluid to an engine, wherein the filtration system includes:
a filter housing assembly;
a filter element assembly being disposed within the filter housing assembly and configured to move between a first position and a second position within the filter housing assembly, the filter element assembly including a top cover;
a suction tube disposed within the filter element assembly;
an axial pin member protruding from the filter element assembly; and
a filter head assembly removably engaged with the filter housing assembly, the filter head assembly including:
   a filter head enclosure including:
      an inlet opening configured to be keyed with the axial pin member at the second position of the filter element assembly and allow fuel to pass while the filter element assembly is present, the inlet opening having a tapered profile; and
      an outlet opening providing a passage to the engine;
   a blocking element disposed within the filter head enclosure for restricting flow of fuel through the inlet opening, the blocking element being movable within the filter head enclosure; and
   a locking cap attached at the outlet opening of the filter head enclosure.

According to the first embodiment of the invention, when the filter element is inserted within the filter housing assembly towards the second position, the axial pin member pushes the blocking element to clear the inlet opening and thereupon allow the flow of fuel towards the outlet opening. Further, when the filter element assembly is removed from the filter housing assembly towards the first position, the blocking element drops along the tapered profile of the inlet opening and restricts the flow of fuel through the inlet opening.

According to the first embodiment of the invention, the locking cap includes an opening having a tapered profile, the opening having a diameter lesser than that of the blocking element. In this embodiment, the axial pin member has a predefined height and diameter and is positioned to be in-line with the inlet opening of the filter head assembly, such that at the second position of the filter element assembly, the opening of the locking cap is kept open.

According to the first embodiment of the invention, the blocking element is a spherical ball having a diameter larger than that of the inlet opening. Further, the filter element assembly includes an annular member press-fitted with the top cover. The axial pin member is formed on the annular member. Alternatively, the axial pin member is formed on either the top cover or on the suction tube.

According to the first embodiment of the invention, the suction tube includes an annular cavity leading to a plurality of meshed slots disposed around the axial pin member, the suction tube being assembled with the top cover.

The present invention, according to a second embodiment provides a filtration system with a “no filter no run” mechanism for providing filtered fluid to an engine, wherein the filtration system includes:
a filter housing assembly;
a filter element assembly being disposed within the filter housing assembly and configured to move between a first position and a second position within the filter housing assembly, the filter element assembly including a top cover;
a suction tube disposed within the filter element assembly;
a protuberance extending from the filter element assembly; and
a filter head assembly removably engaged with the filter housing assembly, the filter head assembly including:
   a filter head enclosure including:
      an inlet opening configured to allow fuel to pass while the filter element assembly is present; and
      an outlet opening providing a passage to the engine;
   a slider cap disposed within the filter head enclosure, the slider cap being biased to cover the inlet opening for restricting flow of fuel through the inlet opening;
   a stopper valve coupled with the slider cap; and
   a biasing member coupled between the slider cap and the stopper valve.

According to the second embodiment of the invention, when the filter element is inserted within the filter housing assembly towards the second position, the protuberance pushes the slider cap against the biasing of the biasing member along the stopper valve to clear the inlet opening and thereupon allow the flow of fuel towards the outlet opening.

According to the second embodiment of the invention, the filter housing assembly is formed with a step around the inlet opening to accommodate the slider cap when the filter element assembly is in the first position. In this embodiment, the stopper valve is a mushroom valve having a first disk and a second disk connected with a shaft, the first disk having a larger diameter than the second disk and having a plurality of meshed slots. The shaft is configured to guide the slide cap to move against the biasing member.

According to the second embodiment of the invention, the biasing member is a compression spring disposed around the shaft of the stopper valve. In this embodiment, the protuberance having a actuate profile formed as an extension of the suction tube. The protuberance has an actuate profile formed on the suction tube. Alternatively, the protuberance is formed on the top cover.

Further, the present invention in its third embodiment, proposes a filtration system with a “no filter no run” mechanism for providing filtered fluid to an engine, wherein the filtration system includes:
a filter housing assembly;
a filter element assembly being disposed within the filter housing assembly and configured to move between a first position and a second position within the filter housing assembly, the filter element assembly including a top cover;
a suction tube disposed within the filter element assembly;
a plurality of protruding lips defining female slots; and
a filter head assembly removably engaged with the filter housing assembly, the filter head assembly including:
   a filter head enclosure including:
      an inlet opening configured to allow fuel to pass while the filter element assembly is present; and
      an outlet opening providing a passage to the engine;
   a movable lock slider disposed within the filter head enclosure for restricting flow of fuel through the inlet opening, the lock slider including:
      a cylindrical stopper;
      plurality of male ribs disposed around an outer surface of the lock slide; and
      a plurality of extension legs; and
   a stationary guide member mounted adjacent to the outlet opening, the guide member including spaced apart slots configured to receive the extension legs.

According to the third embodiment of the invention, when the filter element is inserted within the filter housing assembly towards the second position, the male ribs interact with the female slots to rotate the lock slider such that the extension legs engage with the corresponding slots, and the protruding lips push the cylindrical stopper to clear the inlet opening and thereupon allow the flow of fuel towards the outlet opening.

According to the third embodiment of the invention, the plurality of protruding lips are formed at an inner circumference of the suction tube. Alternatively, the plurality of protruding lips are formed at an inner circumference of the top cover. The extension legs include a pair of oppositely disposed legs extending away from the inlet opening towards the guide member.

According to the third embodiment of the invention, the guide member is a hollow disc member having an outer periphery formed with the spaced apart slots to receive the extension legs, and an inner periphery to allow fuel to flow towards the outlet opening when the filter element assembly is at the second position. The spaced apart slots are formed with a profile corresponding with the extension legs.

According to the third embodiment of the invention, the cylindrical stopper has a matching profile with the inlet opening such that the lock slider seals the inlet opening at the first position of the filter element assembly. The filter head assembly is formed with a chamfered profile at the inlet opening to accommodate the lock slider when the filter element assembly is in the first position.

In the aforesaid embodiments, the first position is defined as the position where the filter element does not interact with the filter head assembly.

### BRIEF DESCRIPTION OF DRAWINGS

FIG. 1 depicts a front view of a filtration system with a “no filter no run” mechanism according to a first embodiment of the invention.

FIG. 2 shows a sectional view of a filtration system with a “no filter no run” mechanism according to the first embodiment of the invention.

FIG. 3 is a perspective view of the filter head assembly according to the first embodiment of the invention.

FIG. 4 is a perspective view of the filter element assembly according to the first embodiment of the invention.

FIG. 5 is a perspective view of the filter housing assembly according to the first embodiment of the invention.

FIGS. 6-7 depict a front view and a sectional view, respectively, of the filter head assembly according to the first embodiment of the invention.

FIGS. 8(a)-8(b) depict a front view and a top perspective view, respectively, of the filter head assembly according to the first embodiment of the invention.

FIGS. 9(a)-9(b) depict a perspective cut-out view and front sectional view, respectively, of the filter element assembly according to the first embodiment of the invention.

FIG. 10 is a perspective cut away view of the suction tube according to the first embodiment of the invention.

FIGS. 11(a)-11(b) are a sectional front view and perspective view, respectively, of the filtration system when the filter element assembly is not inserted according to the first embodiment of the invention.

FIG. 12 is a sectional front view of the filter head assembly when the filter element assembly is not inserted according to the first embodiment of the invention.

FIGS. 13(a)-13(b) are a sectional perspective view and front view, respectively, of the filtration system when the filter element assembly is inserted according to the first embodiment of the invention.

FIG. 14 is a sectional front view of the filter head assembly when the filter element assembly is inserted according to the first embodiment of the invention.

FIG. 15 depicts a front view of a filtration system with a “no filter no run” mechanism according to a second embodiment of the invention.

FIG. 16 shows a sectional view of the filtration system as shown in FIG. 15.

FIG. 17 is a perspective view of the filter head assembly according to the second embodiment of the invention.

FIG. 18 is a perspective view of the filter element assembly according to the second embodiment of the invention.

FIG. 19 is a perspective view of the filter housing assembly according to the second embodiment of the invention.

FIG. 20 depicts a sectional view of the filter head assembly according to the second embodiment of the invention.

FIG. 21 depicts a close-up sectional view of the mechanism of the filter head assembly according to the second embodiment of the invention.

FIG. 22 is a perspective view of the slider cap, stopper valve and biasing member in the filter head assembly as shown in FIG. 21.

FIGS. 23(a)-23(b) depict a perspective cut-out view and front sectional view, respectively, of the filter element assembly according to the second embodiment of the invention.

FIG. 24 is a perspective cut away view of the suction tube according to the second embodiment of the invention.

FIG. 25 is a sectional front view of the filtration system when the filter element assembly is not inserted according to the second embodiment of the invention.

FIG. 26 is a close-up sectional front view of the filter head assembly when the filter element assembly is not inserted according to the second embodiment of the invention.

FIG. 27 depicts another sectional front view of the filtration system when the filter element assembly is inserted according to the second embodiment of the invention.

FIG. 28 is another close-up sectional front view of the filter head assembly when the filter element assembly is inserted according to the second embodiment of the invention.

FIG. 29 depicts a front view of a filtration system with a “no filter no run” mechanism according to a third embodiment of the invention.

FIG. 30 is a sectional view of the filtration system as shown in FIG. 29.

FIG. 31 is a perspective view of the filter head assembly according to the third embodiment of the invention.

FIG. 32 is a perspective view of the filter element assembly according to the third embodiment of the invention.

FIG. 33 is a perspective view of the filter housing assembly according to the third embodiment of the invention.

FIG. 34 depicts a sectional view of the filter head assembly according to the third embodiment of the invention.

FIG. 35 depicts a close-up sectional view of the mechanism of the filter head assembly according to the third embodiment of the invention.

FIG. 36 depicts a perspective view of the lock slider according to the third embodiment of the invention.

FIG. 37 depicts a perspective view of the guide member according to the third embodiment of the invention.

FIGS. 38(a)-38(b) depict a front sectional view and a perspective cut-out view, respectively, of the filter element assembly according to the third embodiment of the invention.

FIGS. 39(a) and 39(b) show a perspective cut away view and top view, respectively, of the suction tube according to the third embodiment of the invention.

FIG. 40 is a sectional front view of the filtration system when the filter element assembly is not inserted according to the third embodiment of the invention.

FIGS. 41(a) and 41(b) are a close-up sectional front view and a top view, respectively, of the filter head assembly when the filter element assembly is not inserted according to the third embodiment of the invention.

FIG. 42 is a sectional front view of the filtration system when the filter element assembly is inserted according to the third embodiment of the invention.

FIGS. 43(a) and 43(b) are a close-up sectional front view and a top view, respectively, of the filter head assembly when the filter element assembly is inserted according to the third embodiment of the invention.

### DETAILED DESCRIPTION

In the following, numerous specific details are set forth to provide a thorough description of embodiments of the invention. Those skilled in the art will recognize and appreciate that, despite of the detailed nature of the exemplary embodiments provided herein; changes and modifications may be applied to the embodiments without limiting or departing from the generally intended scope.

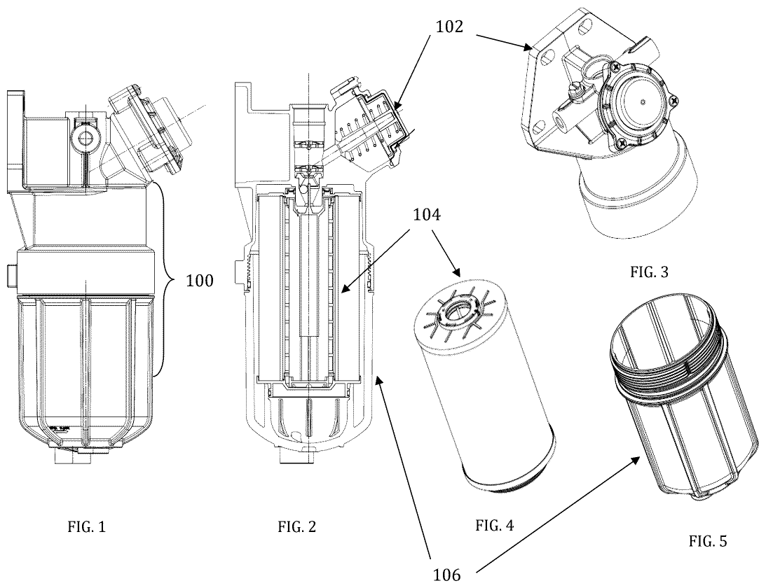

With reference to FIGS. 1 to 14, a first embodiment of a filtration system (100) with a “no filter no run” mechanism is depicted. The filtration system (100) comprises a filter housing assembly (106), a filter head assembly (102), and a filter element assembly (104) specific to this embodiment of the filtration system (100). In the filtration system (100), unless a designated filter element assembly (104) is installed, the flow of fuel into an engine is blocked preventing damage to the engine. As the designated filter element is installed, as shown in the sectional view of FIG. 2, it interacts with the filter head assembly (102), allowing filtered fluid to be supplied to the engine.

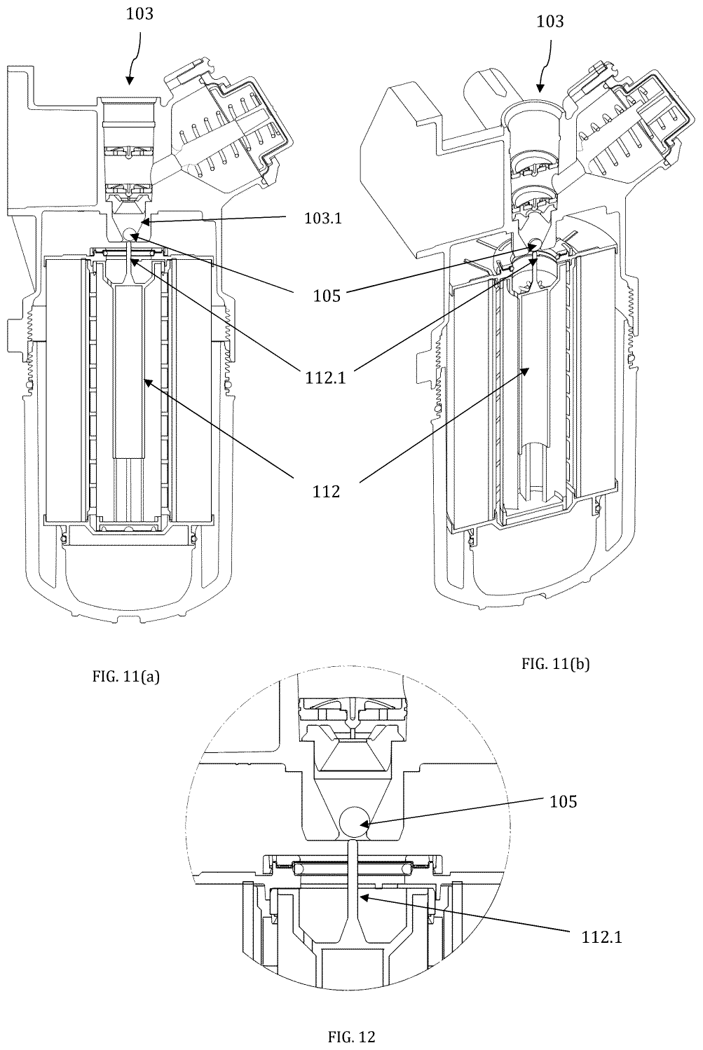

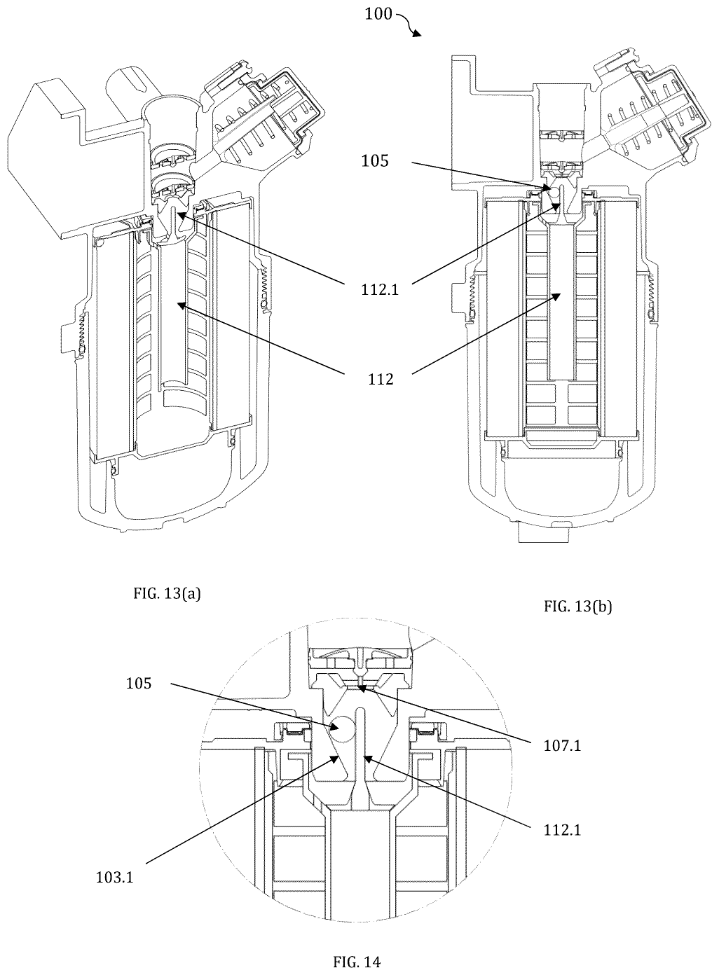

FIGS. 4, 5 and 6 show the perspective views of the filter head assembly (102), the filter element assembly (104) and the filter housing assembly (106), respectively. The filter element assembly (104) is disposed in a movable manner inside the filter housing assembly (106) between a first position and a second position. At the first position, the filter element assembly (104) does not interact with the filter housing assembly (106), as illustrated in FIGS. 11(a) to 12. Whereas in the second position, the filter element assembly (104) interacts with the filter housing assembly (106) in a predefined manner to allow filtered fluid to be supplied to the engine, as illustrated in FIGS. 13(a) to 14. The filtration system (100) further comprises a locking cap (107) according to FIGS. 8(a) and 8(b), disposed within the filter head assembly (102).

As apparent from the drawing figures, the filter housing assembly (106) is provided with a threaded outer circumference to be attached with a correspondingly threaded receiving portion at the inner circumference of the filter head assembly (102). This creates a hollow path towards the filter head assembly (102) for the filter element assembly (104) to interact with the filter head assembly (102).

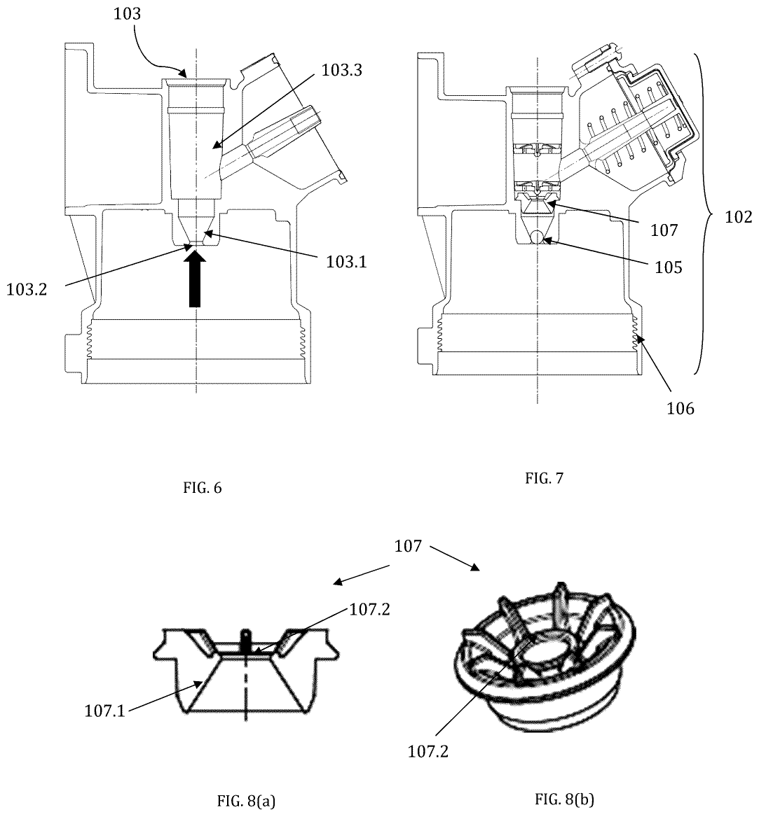

With reference to FIGS. 6 and 7, filter head assembly (102) comprises a filter head enclosure (103), a blocking element (105) and the locking cap (107). The filter head enclosure (103) is formed with an inlet opening (103.2) and an outlet opening (103.3) defining a passage for the filter fluid to flow and reach the engine. As shown in the sectional view of FIG. 7, the locking cap (107) has a tapered profile (107.1) and is disposed at the outlet opening (103.3), and subsequently, the blocking element (105) stays and blocks the inlet opening (103.2). The inlet opening (103.2) is formed with a tapered profile (103.1) which biases the blocking element (105), due to its own weight, to fall right back at the inlet opening (103.2) as the filter element assembly (104) is moved to its first position. The blocking element (105) is a spherical ball having a diameter larger than that of the inlet opening (103.2). Similarly, the tapered profile (107.1) of the locking cap (107) leads to an opening (107.2) having a diameter lesser than that of the blocking element (105). The opening (107.2) allows filtered fuel to reach the engine when the filter element assembly (104) is in its second position.

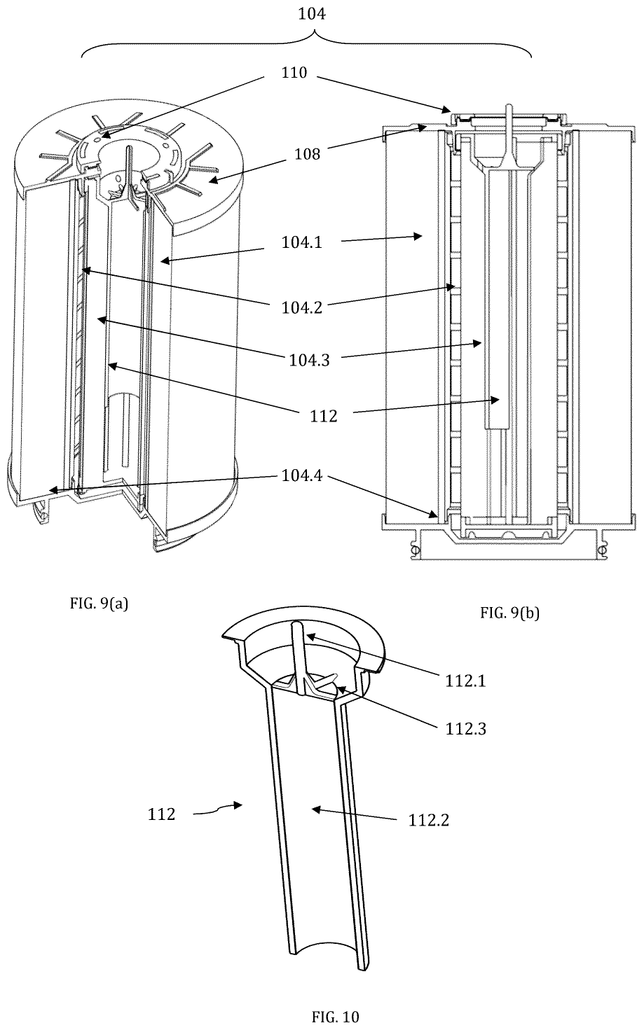

As shown in FIGS. 9(a) to 10, the filter element assembly (104) comprises a top cover (108), a bottom cover (104.4) and an annular member (110) press-fitted with the top cover (108). The suction tube (112) shown in FIG. 10 is disposed within the filter element assembly (104) having a filter media (104.1), a coil form (104.2), and a strainer insert (104.3). These elements are assembled together, for example by gluing, and positioned between the top cover (108) and bottom cover (104.4). The suction tube (112), according to this embodiment is attached with the top cover (108) and provided with an axial pin member (112.1) protruding from the filter element assembly (104). The detailed description of the filter media (104.1), the coil form (104.2), the strainer insert (104.3), and the mechanism of filtration is avoided for the sake of brevity.

The suction tube (112) of FIG. 10 comprises an annular cavity (112.2) leading to a plurality of meshed slots (112.3). The axial pin member (112.1) is formed at a midpoint of the meshed slots (112.3) extending in an outwardly manner from the filter element assembly (104). With reference to FIG. 9(a), the axial pin member (112.1) extends through the annular member (110). As the filtered fuel is filled in the annular cavity (112.2) of the suction tube (112), it travels through the meshed slots (112.3) and enters the filter head assembly (102), considering the specific filter element assembly (104) having the axial pin member (112.1) is installed within the filter housing assembly (106). Now, the formation of axial pin member (112.1) is not limited to the suction pipe. Alternatively, the axial pin member may be formed on the annular member (110) or on the top cover (108) such that it extends from the filter element assembly (104) and at the second position of the filter element assembly (104) gets keyed into the inlet opening (103.2).

The mechanism of the filtration system (100) according the first embodiment is depicted in FIGS. 11(a) to 14. At the first position of the filter element shown in FIGS. 11(a)-12, the axial pin member (112.1) stays below the inlet opening (103.2) of the filter head assembly (102). In this position, the blocking element (105) due to its own weight remains fixed at the inlet opening (103.2) having the tapered profile (103.1). Thus, in the absence of the filter element assembly (104) with the axial pin member (112.1), no unfiltered fuel is allowed to enter the engine.

With reference to FIGS. 13(a)-14, as the filter element assembly (104) is brought to its second position, the axial pin member (112.1) interacts with the filter head assembly (102) and gets keyed with the inlet opening (103.2). In this position, the blocking element (105) moves away from the inlet opening (103.2) creating a path for the fuel to flow towards the outlet opening (103.3). As shown in FIG. 14, the movement of the blocking element (105) is carried out in a restrictive manner as it stays in contact with the tapered profile (103.1) of the inlet opening (103.2) and the axial pin member (112.1). This ensures that opening (107.2) formed at the locking cap (107) is not accidentally blocked by the blocking element (105). Further, the opening (107.2) of the locking cap (107) is formed of a smaller diameter than that of the blocking element (105). The dimensions, specifically, the height and diameter of the axial pin member (112.1) are selected such that at the second position of the filter element assembly (104), the axial pin member (112.1) does not block either the inlet opening (103.2) or the opening (107.2) of the locking cap (107).

Therefore, with the insertion of the filter element assembly (104) to its second position within the filter housing assembly (106), the filter fuel flows though the passage of the outlet opening (103.3) to reach the engine. Consequently, when the filter element assembly (104) is removed from the filter housing assembly (106) towards the first position, the blocking element (105) drops along the tapered profile (103.1) of the inlet opening (103.2) in a guided manner. Once the blocking element (105) reaches the inlet opening (103.2), it gets sealed and again restricts the flow of fuel through the inlet opening (103.2).

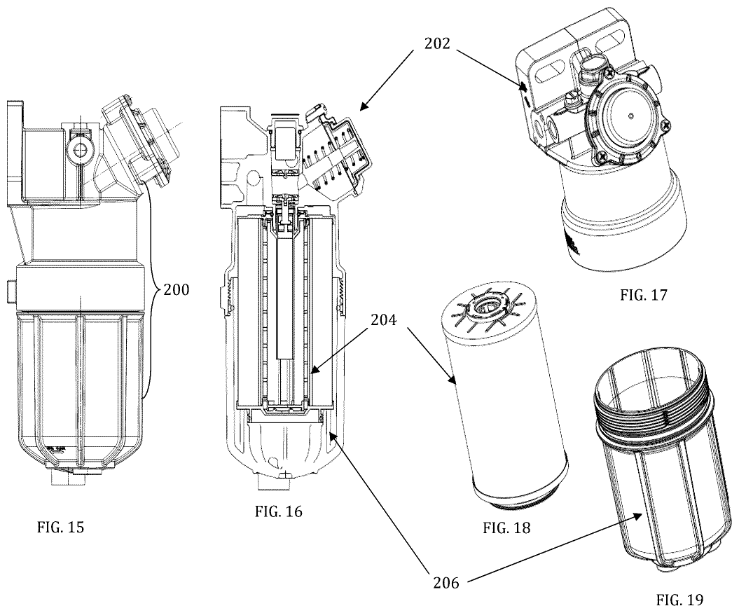

With reference to FIGS. 15 to 28, a second embodiment of a filtration system (200) with a “no filter no run” mechanism is depicted. Similar to the first embodiment, the filtration system (200) comprises a filter housing assembly (206), a filter head assembly (202), and a filter element assembly (204), wherein the filter housing assembly (206) and the filter element assembly (204) are connected with respective threaded portions. The filter element assembly (204) is specific to this second embodiment of the filtration system (200). As depicted in sectional view in FIGS. 16 and 28, when the designated filter element assembly (204) is installed within the filter housing assembly (206), it interacts with the filter head assembly (202), allowing filtered fluid to be supplied to the engine. The perspective views of the filter head assembly (202), the filter element assembly (204) and the filter housing assembly (206) are shown in FIGS. 17, 18 and 19, respectively.

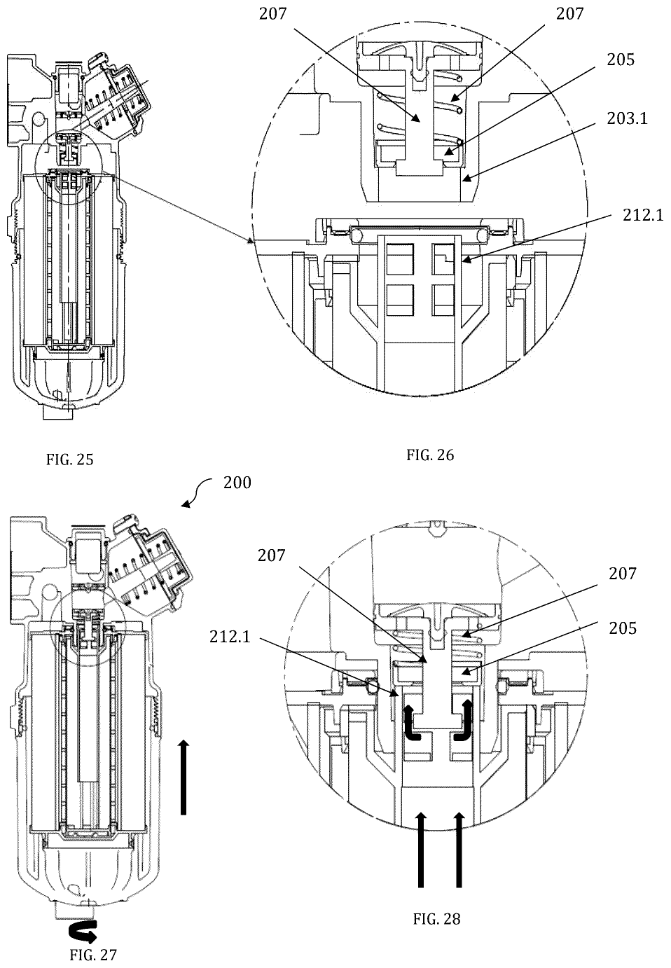

At a first position as shown in FIG. 25, the filter element assembly (204) does not interact with the filter housing assembly (206). Whereas at a second position as shown in FIG. 27, the filter element assembly (204) interacts with the filter housing assembly (206) in a predefined manner to allow filtered fluid to be supplied to the engine. The flow of the filtered fuel is illustrated by arrows in FIG. 28.

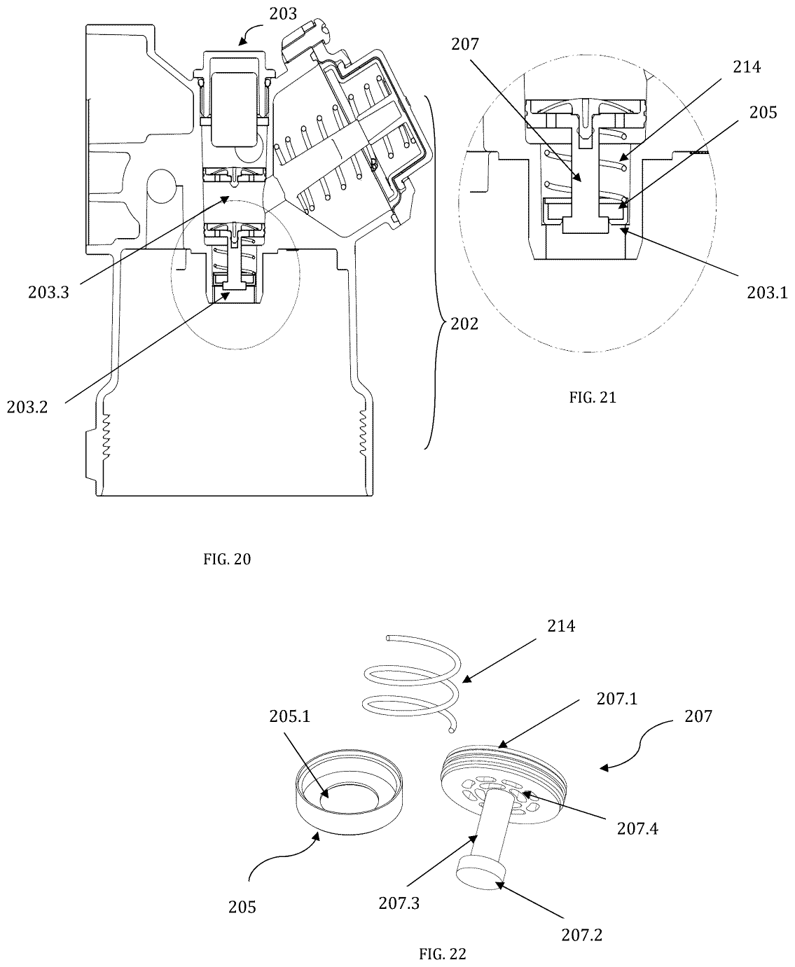

With reference to FIGS. 20 to 22, filter head assembly (202) comprises a filter head enclosure (203), a slider cap (205), a stopper valve (207) and a biasing member (214). The stopper valve (207) is coupled with the slider cap (205) and the biasing member (214) is coupled between the slider cap (205) and the stopper valve (207). The filter head enclosure (203) is formed with an inlet opening (203.2), an outlet opening (203.3) defining a passage for the filter fluid to flow and reach the engine. As shown in FIG. 22, the biasing member (214) is for example a compression spring. The biasing member (214) stays in a relaxed state at the first position of the filter element assembly (204), and when in the second position, the biasing member (214) is compressed.

As shown in the close-up sectional view of FIG. 21, filter head assembly (202) is formed with a step (203.1) around the inlet opening (203.2). The step (203.1) is configured to accommodate the slider cap (205) when the filter element assembly (204) is in the first position. The biasing force from the biasing member (214) pushes the slider cap (205) to be fitted on the step (203.1). With reference to FIG. 22 of the accompanying drawing figures, the stopper valve (207) is a mushroom valve having a first disk (207.1) and a second disk (207.2) connected with a shaft (207.3). The length of the shaft (207.3) is proportional to the biasing member (214) as the biasing member (214) is disposed around the shaft (207.3).

According to this second embodiment, the first disk (207.1) is formed with a larger diameter than the second disk (207.2). The slider cap (205) is formed with an opening (205.1) having a diameter matching with the diameter of the smaller disk such that when the slider cap (205) rests on the step (203.1) of the inlet opening (203.2), the flow of unfiltered fuel in blocked. The larger disk is provided with a plurality of meshed slots (207.4) disposed around its central region. When the filter element according this second embodiment of the filtration system (200) is moved to its second position, fuel passes through the plurality of meshed slots (207.4) towards the passage of the outlet opening (203.3). As the filter element is moved from its first position to its second position, the shaft (207.3) is configured to guide the slider cap (205) to move against the biasing member (214).

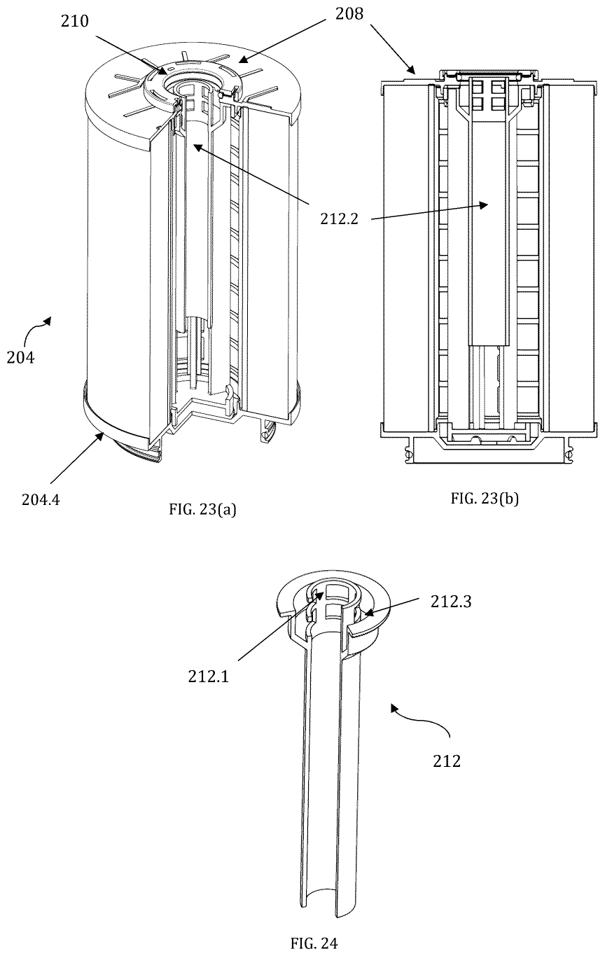

With reference to FIGS. 23(a) to 24, similar to the first embodiment, the filter element assembly (204) comprises a top cover (208), a bottom cover (204.4) and an annular member (210) press-fitted with the top cover (208). The suction tube (212) as shown in FIG. 24, according to an embodiment is attached with the top cover (208) and provided with an annular cavity (212.2) and a protuberance (212.1) extending from the filter element assembly (204). The protuberance (212.1) formed at the suction tube (212) comprises a plurality of meshed slots (212.3). With reference to FIG. 23(a), the protuberance (212.1) has an arcuate profile and extends through the annular member (210).

When a designated filter element assembly (204) having the axial protuberance (212.1) is installed within the filter housing assembly (206), the filtered fuel is filled within the cavity (212.2) of the suction tube (212), travels through the meshed slots (212.3) and enters the filter head assembly (202). Now, the formation of protuberance (212.1) is not limited to the suction pipe. Alternatively, protuberance (212.1) may be formed on the annular member (210) or on top cover (208) such that it extends from the filter element assembly (204). As the filter element assembly (204) is moved to its second position, the protuberance (212.1) interacts with the slider cap (205) allowing fuel to be passed through the inlet opening (203.2).

The mechanism of the filtration system (200) according to the second embodiment is depicted in FIGS. 25 to 28. At the first position of the filter element shown in FIGS. 25 and 26, the protuberance (212.1) member stays below of the inlet opening (203.2) of filter head assembly (202). In this position, the biasing member (214) pushes the slider cap (205) toward the step (203.1) on the inlet opening (203.2). Further, due to the smaller disk of the stopper valve (207), the slider cap (205) remains fixedly placed at the inlet opening (203.2) having the step (203.1) formed therein. Thus, in the absence of the filter element assembly (204) with the protuberance (212.1), no unfiltered fuel is allowed to enter the engine.

With reference to FIGS. 27 and 28, as the filter element assembly (204) is brought to its second position, the protuberance (212.1) interacts with the slider cap (205) of the filter head assembly (202) and pushes it against the biasing member (214). In this position, the biasing member (214) gets compressed, and the slider cap (205) moves away from the inlet opening (203.2) creating a path for the fuel to flow through the inlet opening (203.2) towards the outlet opening (203.3). In FIG. 28, the flow of the fuel is shown with arrows. The movement of the slider cap (205) is carried out in a guided manner along the shaft (207.3) of the stopper valve (207). This ensures a continuous supply of filtered fuel towards the passage of the outlet opening (203.3) to reach the engine, as long as the filter element assembly (204) is present in the second position.

Consequently, when the filter element assembly (204) is removed from the filter housing assembly (206) towards the first position, the biasing member (214) pushes the slider cap (205) along the shaft (207.3) of the stopper valve (207) in a guided manner. Once the slider cap (205) reaches the inlet opening (203.2), it gets sealed and again restricts the flow of fuel through the inlet opening (203.2).

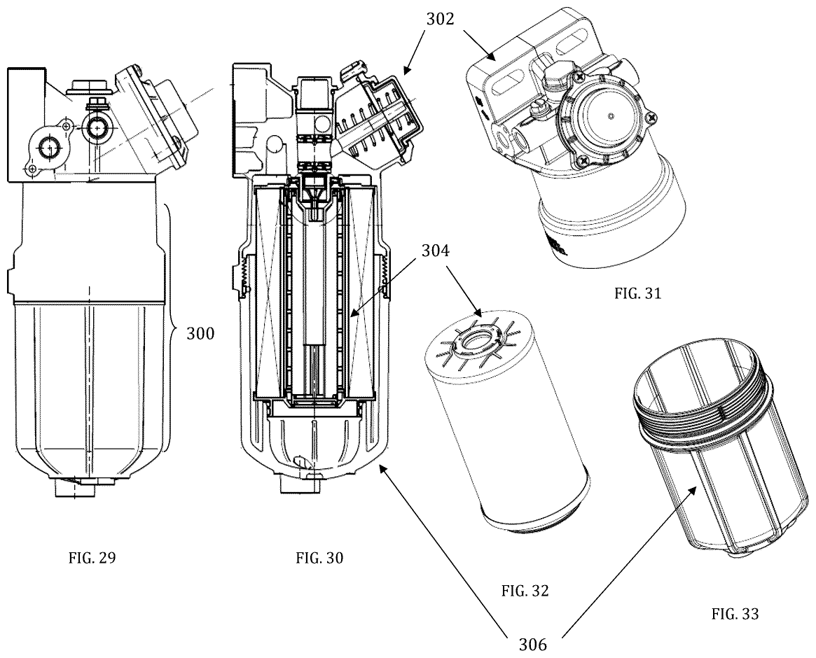

With reference to FIGS. 29 to 43(b), a third embodiment of a filtration system (300) with a “no filter no run” mechanism is depicted. Similar to the first and second embodiment, the filtration system (300) comprises a filter housing assembly (306), a filter head assembly (302), and a filter element assembly (304), wherein the filter housing assembly (306) and the filter element assembly (304) are connected with respective threaded portions. The filter element assembly (304) is specific to this third embodiment of filtration system (300). As depicted in sectional view in FIGS. 30 and 43(b), when the designated filter element is installed within the filter housing assembly (306), it interacts with the filter head assembly (302), allowing filtered fluid to be supplied to the engine. The perspective views of the filter head assembly (302), the filter element assembly (304) and the filter housing assembly (306) are shown in FIGS. 31, 32 and 33, respectively.

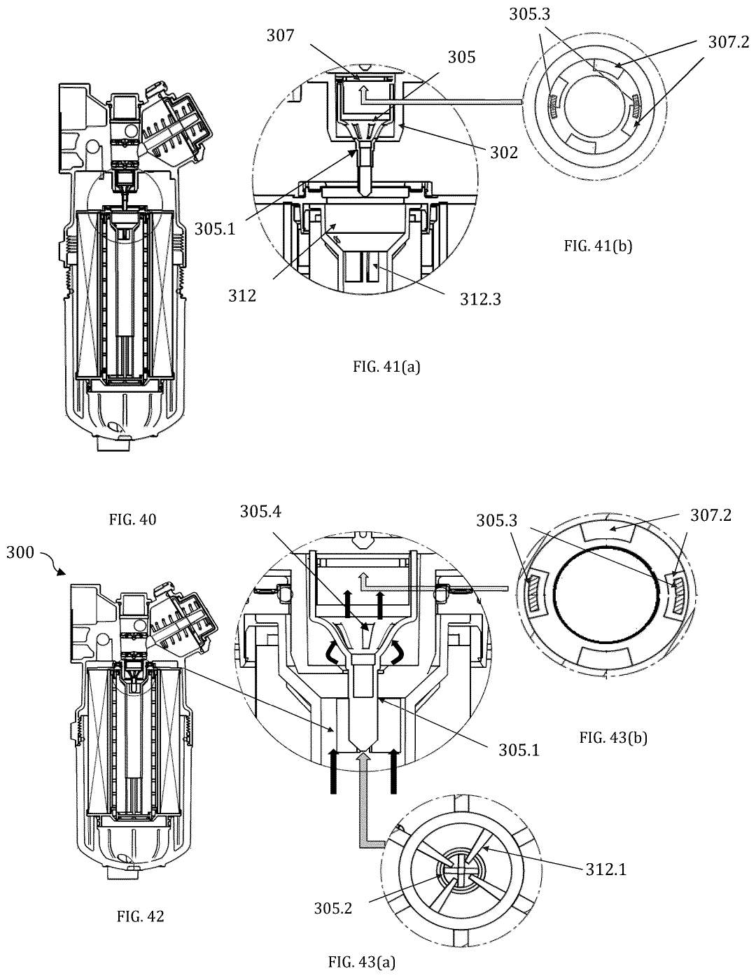

At a first position as shown in FIG. 40, the filter element assembly (304) does not interact with the filter housing assembly (306). Whereas at a second position as shown in FIG. 42, the filter element assembly (304) interacts with the filter housing assembly (306) in a predefined manner to allow filtered fluid to be supplied to the engine. The flow of the filtered fuel is illustrated by arrows in FIG. 43(a).

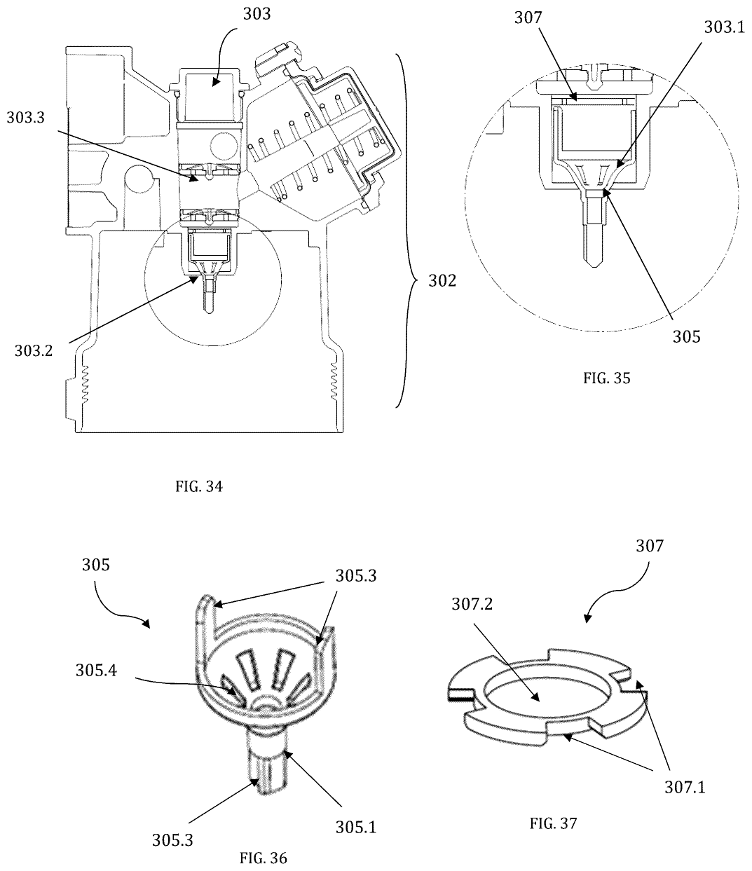

With reference to FIGS. 34 to 37, filter head assembly (302) comprises a filter head enclosure (303), a movable lock slider (305), and a stationary guide member (307). As shown in FIG. 36, the lock slider (305) is formed in a funnel shape and comprises a cylindrical stopper (305.1), a plurality of male ribs (305.2) and a plurality of extension legs (305.3). The male ribs (305.2) are disposed around an outer surface of lock slider (305). The extension legs (305.3), according to an embodiment, comprise a pair of oppositely disposed legs extending away from the inlet opening (303.2) towards the guide member (307). The cylindrical stopper (305.1) is formed with a matching diameter with the inlet opening (303.2).

The filter head enclosure (303) is formed with an inlet opening (303.2), and an outlet opening (303.3) defining a passage for the filter fluid to flow and reach the engine. As shown in FIG. 37, the guide member (307) is a hollow disc member having an outer periphery formed with the spaced apart slots (307.1). The spaced apart slots (307.1) have a profile that corresponds with that of the extension legs (305.3). The inner periphery of the guide member (307) forms an opening (307.2) to allow fuel to flow towards the outlet opening (303.3) when the filter element assembly (304) is moved to its second position. As the filter element assembly (304) is moved from the first position towards the second position the lock slider (305) is moved along the passage of the inlet opening (303.2) and the outlet opening (303.3).

As shown in the close-up sectional view of FIG. 35, the filter head assembly (302) is formed with a chamfered profile (303.1) at the inlet opening (303.2). The chamfered profile (303.1) is configured to accommodate the funnel-shaped lock slider (305) when the filter element assembly (304) is in the first position. The lock slider (305) is also provided with meshed slots (305.4) to allow filtered fuel to travel towards the outlet opening (303.3) as the filter element assembly (304) is brought to its second position. The lock slider (305) may retain some of the fuel that passed through the meshed slots (305.4). Due to the weight of this fuel as well as its own weight, the lock slider (305) is biased to fall back in a guided manner to the chamfered profile (303.1) on the inlet opening (303.2), as shown in FIG. 34.

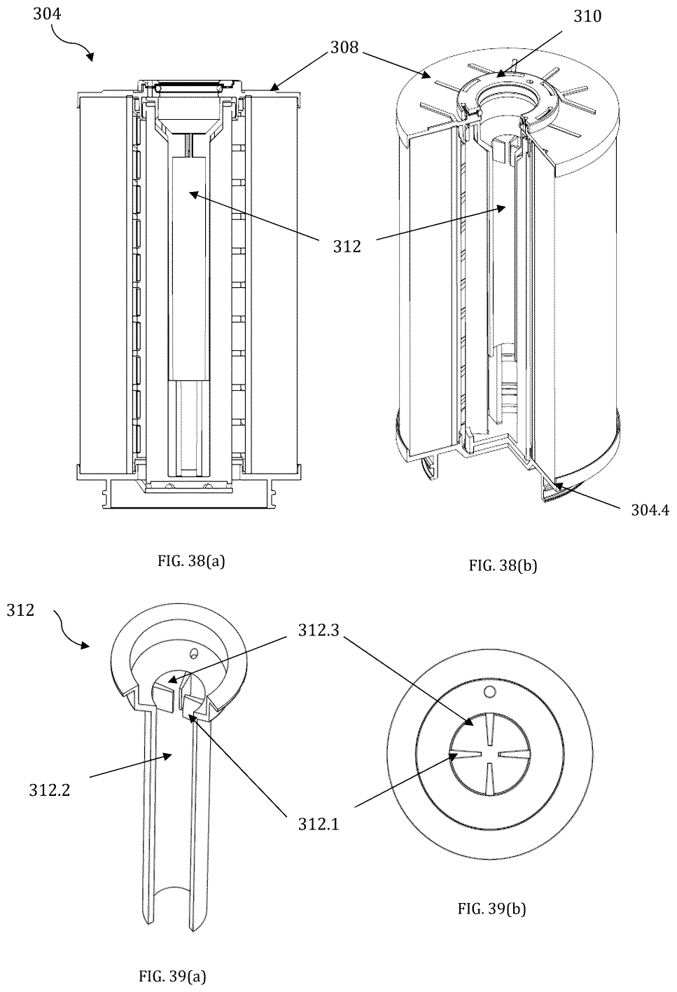

As shown in FIGS. 38(a) to 39(b), similar to the first and second embodiments, the filter element assembly (304) comprises a top cover (308), a bottom cover (304.4) and an annular member (310) press-fitted with the top cover (308). The suction tube (312) as shown in FIG. 39(a), according to this embodiment is attached with the top cover (308) and provided with an annular cavity (312.2) and a plurality of protruding lips (312.1) formed within the annular cavity (312.2) defining female slots (312.3). With reference to FIG. 39(b), the protruding lips (312.1) are formed in oppositely disposed pairs defining the female slots (312.3) that correspond to the male ribs (305.2) of the lock slider (305).

When a designated filter element assembly (304) having protruding lips (312.1) formed in oppositely disposed pairs defining the female slots (312.3) is installed within the filter housing assembly (306), the filtered fuel is filled within the cavity (312.2) of the suction tube (312) and travels within the filter head assembly (302). Now, the formation of the protruding lips (312.1) defining the female slots (312.3) is not limited to the suction pipe. Alternatively, the protruding lips (312.1) may be formed on the annular member (310) or on top cover (308) such that it defines the female slots (312.3) to interact with the male ribs (305.2) of the lock slider (305) to allow fuel to be passed through the inlet opening (303.2).

The mechanism of the filtration system (300) according to the third embodiment is depicted in FIGS. 40 to 43(b). At the first position of the filter element shown in FIGS. 40 and 41(a), the filter element assembly (304) including the suction tube (312) stays below the inlet opening (303.2) of filter head assembly (302). In this position, due to its own weight, the lock slider (305) is biased to be fixedly engaged at the chamfered profile (303.1) on the inlet opening (303.2) with the cylindrical stopper (305.1). Further, as illustrated in the FIG. 41(b), in this position the extension legs (305.3) may not be in-line with the slots (307.1) on the guide member (307). Thus, in the absence of the filter element assembly (304) with the protruding lips (312.1) defining the female slots (312.3), no unfiltered fuel is allowed to enter the engine.

With reference to FIGS. 42 to 43(b), as the filter element assembly (304) is brought to its second position, the male ribs (305.2) on the lock slider (305) interact with the female slots (312.3) to rotate the lock slider (305). In this position, the lock slider (305) moves away from the inlet opening (303.2) towards the guide member (307) creating a path for the fuel to flow through the inlet opening (303.2) towards the outlet opening (303.3). In FIG. 43(a), the flow of the fuel is shown with arrows. Due to the interaction between the male ribs (305.2) on the lock slider (305) that interact with the female slots (312.3), the extension legs (305.3) finally come in-line with the slots (307.1) on the guide member (307). The extension legs (305.3) are received within the slots (307.1) and the opening (307.2) of its inner circumference allows fuel to pass towards the passage of the outlet opening (303.3) as shown in FIG. 43(b). This ensures a continuous supply of filtered fuel towards the passage of the outlet opening (303.3) to reach the engine as long as the filter element assembly (304) is present in the second position.

Consequently, when the filter element assembly (304) is removed from the filter housing assembly (306) towards the first position, the weight of the retained fuel within the lock slider (305) as well as its own weight brings the lock slider (305) towards the chamfered profile (303.1) on the inlet opening (303.2) in a guided manner. Once the lock slider (305) with the cylindrical stopper (305.1) reaches the inlet opening (303.2), it gets sealed and again restricts the flow of fuel through the inlet opening (303.2).

As already mentioned, the foregoing description is illustrative of the invention and is not limiting to its scope, because it will be apparent to persons skilled in the art to devise other alternative embodiments without departing from the broad ambit of the disclosures made herein.

### Reference Characters

Filtration system 100,200,300
Filter head assembly 102,202,302
Filter head enclosure 103,203,303
Tapered profile 103.1
Step 203.1
Chamfered profile 303.1
Inlet opening 103.2, 203.2,303.2
Outlet opening 103.3,203.3,303.3
Filter element assembly 104,204,304
Filter media 104.1
Coil form 104.2
Strainer insert 104.3
Bottom cover 104.4,204.4,304.4
Blocking element 105
Slider cap 205
Opening 205.1
Lock slider 305
Cylindrical stopper 305.1
Male ribs 305.2
Extension legs 305.3
Meshed slots 305.4
Filter housing assembly 106,206,306
Locking cap 107
Opening 107.2
Stopper valve 207
First disk 207.1
Second disk 207.2
Shaft 207.3
Meshed slots 207.4
Stationary guide member 307
Spaced apart slots 307.1
Opening 307.2
Top cover 108,208,308
Annular member 110,210,310
Suction tube 112,212,312
Axial pin member 112.1
Protuberance 212.1
Protruding lips 312.1
Female slots 312.3
Cavity 112.2, 212.2,312.2
Meshed slots 112.3,212.3
Biasing member 214

That which is claimed is:

1. A filtration system with a “no filter no run” mechanism for providing filtered fluid to an engine, wherein the filtration system comprises:
a filter housing assembly;
a filter element assembly being disposed within the filter housing assembly and configured to move between a first position and a second position within the filter housing assembly, the filter element assembly comprising a top cover;
a suction tube disposed within the filter element assembly;
an axial pin member protruding from the filter element assembly; and
a filter head assembly removably engaged with the filter housing assembly, the filter head assembly comprising:
a filter head enclosure comprising:
an inlet opening configured to be keyed with the axial pin member at the second position of the filter element assembly and allow fuel to pass when the filter element assembly is present, the inlet opening having a tapered profile; and
an outlet opening providing a passage to the engine;
a blocking element disposed within the filter head enclosure for restricting flow of fuel through the inlet opening, the blocking element being movable within the filter head enclosure; and
a locking cap attached at the outlet opening of the filter head enclosure,
wherein when the filter element assembly is inserted within the filter housing assembly towards the second position, the axial pin member pushes the blocking element to clear the inlet opening and thereupon allow the flow of fuel towards the outlet opening, and
wherein, when the filter element assembly is removed from the filter housing assembly towards the first position, the blocking element drops along the tapered profile of the inlet opening and restricts the flow of fuel through the inlet opening.

2. The filtration system as claimed in claim 1, wherein the locking cap comprises an opening having a tapered profile, the opening having a diameter lesser than that of the blocking element, and wherein the blocking element is a spherical ball having a diameter larger than that of the inlet opening.

3. The filtration system as claimed in claim 1, wherein the axial pin member has a predefined height and a predefined diameter and is positioned to be in-line with the inlet opening of the filter head assembly, such that at the second position of the filter element assembly, the opening of the locking cap is kept open.

4. The filtration system as claimed in claim 1, wherein the filter element assembly comprises an annular member press-fitted with the top cover.

5. The filtration system as claimed claim 4, wherein the axial pin member is formed on the annular member.

6. The filtration system as claimed in claim 4, wherein the axial pin member is formed on the top cover.

7. The filtration system as claimed in claim 4, wherein the axial pin member is formed on the suction tube.

8. The filtration system as claimed in claim 7, wherein the suction tube comprises an annular cavity leading to a plurality of meshed slots disposed around the axial pin member, the suction tube being assembled with the top cover.

9. A filtration system with a “no filter no run” mechanism for providing filtered fluid to an engine, wherein the filtration system comprises:
a filter housing assembly;
a filter element assembly being disposed within the filter housing assembly and configured to move between a first position and a second position within the filter housing assembly, the filter element assembly comprising a top cover;
a suction tube disposed within the filter element assembly;
a protuberance extending from the filter element assembly; and
a filter head assembly removably engaged with the filter housing assembly, the filter head assembly comprising:
a filter head enclosure comprising:
an inlet opening configured to allow fuel to pass when the filter element assembly is present; and
an outlet opening providing a passage to the engine;
a slider cap disposed within the filter head enclosure, the slider cap being biased to cover the inlet opening for restricting flow of fuel through the inlet opening;
a stopper valve coupled with the slider cap; and
a biasing member coupled between the slider cap and the stopper valve,
wherein when the filter element assembly is inserted within the filter housing assembly towards the second position, the protuberance pushes the slider cap against the biasing of the biasing member along the stopper valve to clear the inlet opening and thereupon allow the flow of fuel towards the outlet opening.

10. The filtration system as claimed in claim 9, wherein the filter housing assembly is formed with a step around the inlet opening to accommodate the slider cap when the filter element assembly is in the first position.

11. The filtration system as claimed in claim 9, wherein the stopper valve is a mushroom valve comprising a first disk and a second disk connected with a shaft, the first disk having a larger diameter than the second disk and comprising a plurality of meshed slots.

12. The filtration system as claimed in claim 11, wherein the shaft is configured to guide the slide cap to move against the biasing member.

13. The filtration system as claimed in claim 9, wherein the protuberance has an actuate profile formed as an extension of the suction tube.

14. The filtration system as claimed in claim 9, wherein the protuberance is formed on the top cover.

15. A filtration system with a “no filter no run” mechanism for providing filtered fluid to an engine, wherein the filtration system comprises:
a filter housing assembly;
a filter element assembly being disposed within the filter housing assembly and configured to move between a first position and a second position within the filter housing assembly, the filter element assembly comprising a top cover;
a suction tube disposed within the filter element assembly;
a plurality of protruding lips defining female slots; and
a filter head assembly removably engaged with the filter housing assembly, the filter head assembly comprising:
a filter head enclosure comprising:
an inlet opening configured to allow fuel to pass when the filter element assembly is present; and
an outlet opening providing a passage to the engine;
a movable lock slider disposed within the filter head enclosure for restricting flow of fuel through the inlet opening, the lock slider comprising:
a cylindrical stopper;
a plurality of male ribs disposed around an outer surface of the lock slider; and
a plurality of extension legs; and
a stationary guide member mounted adjacent to the outlet opening, the guide member comprising spaced apart slots configured to receive the extension legs,
wherein when the filter element assembly is inserted within the filter housing assembly towards the second position, the male ribs interact with the female slots to rotate the lock slider such that the extension legs engage with the corresponding slots, and the protruding lips push the cylindrical stopper to clear the inlet opening and thereupon allow the flow of fuel towards the outlet opening.

16. The filtration system as claimed in claim 15, wherein the plurality of protruding lips are formed at an inner circumference of the suction tube.

17. The filtration system as claimed in claim 15, wherein the plurality of protruding lips are formed at an inner circumference of the top cover.

18. The filtration system as claimed in claim 15, wherein the guide member is a hollow disc member having an outer periphery formed with the spaced apart slots to receive the extension legs, and an inner periphery defining an opening to allow fuel to flow towards the outlet opening when the filter element assembly is at the second position.

19. The filtration system as claimed in claim 15, wherein the cylindrical stopper has a matching profile with the inlet opening such that the lock slider seals the inlet opening at the first position of the filter element assembly.
